(19) United States
(12) Patent Application Publication
(10) Pub. No.: US 2026/0369895 A1
(43) Pub. Date: Nov. 19, 2026

(54) TRANSPARENT ANTENNA MODULE AND METHOD FOR MANUFACTURING SAME

(71) Applicant: LG ELECTRONICS INC., Seoul (KR)

(72) Inventors: Seongmoon CHO, Seoul (KR); Dongjoo YOU, Seoul (KR); Junseok LEE, Seoul (KR)

(73) Assignee: LG ELECTRONICS INC., Seoul (KR)

(21) Appl. No.: 19/137,869

(22) PCT Filed: Dec. 12, 2023
(86) PCT No.: PCT/KR2023/020456

§ 371 Date: Jun. 11, 2025

(30) Foreign Application Priority Data
Dec. 16, 2022 (KR) 10-2022-0177365

(51) Int. Cl. H01Q 21/28; H01Q 1/12; H01Q 1/24; H01Q 1/32; H01Q 1/38; H01Q 1/40; H01Q 1/44

(52) U.S. Cl. CPC H01Q 21/28; H01Q 1/1271; H01Q 1/243; H01Q 1/3266; H01Q 1/38; H01Q 1/40; H01Q 1/44

(57) ABSTRACT

This method for manufacturing a transparent antenna module comprises: a mask pattern formation step for forming mask patterns for antenna patterning on glass or a transfer substrate; an antenna pattern formation step for forming antenna patterns on the glass or the transfer substrate so as to insert the antenna patterns between the mask patterns; and a mask pattern removal step for removing the mask patterns from the upper portion of the glass or the transfer substrate so that only the antenna patterns are arranged on the glass or the transfer substrate.

### TECHNICAL FIELD

The present disclosure relates to a transparent antenna module. More particularly, the present disclosure relates to a transparent antenna module arranged on a glass pane of a vehicle and a method of manufacturing the transparent antenna module.

### BACKGROUND ART

A transparent antenna module is substantially visually imperceptible to a user due to the high transmissivity of the material and the antenna pattern. However, when the transparent antenna module is actually mounted on the exterior of a product such as a glass pane for a vehicle, a glass pane for a building, a front display pane, the outline of the terminal portion of the transparent antenna module is visually discernible. This visual discernibility does not result from the transmissivity of the antenna itself, but rather from the outline of the terminal portion of the transparent antenna module, which becomes visible due to the boundary of a material of a substrate, a protective layer, or a similar component used in the module. This is because the outer boundary of the material is defined by the limited area of the substrate, the pattern, or the protective layer, and the outline of this end portion is inevitably visually perceptible to the user.

According to the present disclosure, to address these problems, an antenna pattern is directly formed on a glass surface of a product to which the antenna pattern is to be formed, without the use of a transparent substrate or a protective layer in the transparent antenna module. Accordingly, the visibility caused by the outer boundary of the substrate or the protective layer is eliminated. A borderless transparent antenna is realized by forming an antenna pattern within a double-layered glass pane for a vehicle or on one internal side of a display panel.

### DISCLOSURE OF INVENTION

### Technical Problem

One object of the present disclosure is to provide a transparent antenna module and a method of manufacturing the transparent antenna module in order to address the above-mentioned problems and other related problems.

Another object of the present disclosure is to form an antenna pattern directly on a glass surface of a product to which the antenna pattern is to be formed, without the use of a transparent substrate and a protective layer in the transparent antenna module.

Still another object of the present disclosure is to eliminate the visibility caused by the outer boundary of a substrate or a protective layer. Particularly, this object is to realize a borderless transparent antenna by forming an antenna pattern within a double-layered glass pane for a vehicle or on one internal side of a display panel.

### Solution to Problem

In order to accomplish the above-mentioned objects and other related objects, according to one aspect of the present disclosure, there is provided a method of manufacturing a transparent antenna module, the method including: a mask pattern formation step of forming mask patterns for antenna patterning on top of a glass pane or a transfer substrate; an antenna pattern formation step of forming antenna patterns on top of the glass pane or the transfer substrate such that the antenna patterns are positioned between the mask patterns; and a mask pattern removal step of removing the mask patterns from the top of the glass pane or the transfer substrate such that only the antenna patterns remain on top of the glass pane or the transfer substrate.

According to an embodiment, in the method, the antenna patterns may form an antenna region radiating wireless signals. The mask pattern coupled to either of the outermost antenna patterns, among the antenna patterns, may be formed such that a first width thereof is greater than a second width of the mask pattern in the central portion of the antenna region. The mask patterns may be formed such that gaps between the mask patterns may decrease in the central portion of the antenna region, and thus, line widths of metal mesh lines, which correspond to widths of the antenna patterns positioned between the mask patterns, may increase in the central portion.

According to an embodiment of the present disclosure, in the method, the glass pane may be an external glass pane arranged to face outward from a vehicle. The method may further include: a feed line connection step of connecting one end portion of a feed line to one side of the antenna pattern; an adhesive layer formation step of forming an adhesive layer in such a manner to cover the antenna pattern to which the feed line is connected; and an internal-glass-pane attachment step of attaching an internal glass pane to an upper region of the adhesive layer in such a manner as to face inward toward the interior of the vehicle. A second thickness of the adhesive layer may be greater than a first thickness of the antenna pattern.

According to an embodiment, the method may further include: a feed line arrangement step of arranging the feed line on an upper region of the internal glass pane through a lateral surface of the adhesive layer and a lateral surface of the internal glass pane; and a cable connection step of connecting the other end portion of the feed line arranged on the upper region of the internal glass pane to an RF cable.

According to an embodiment, in the method, the glass pane may be an external glass pane arranged to face inward toward the interior of a vehicle. The method may include a feed line connection step of connecting one end portion of a feed line to one side of the antenna pattern; an adhesive layer formation step of forming an adhesive layer in such a manner as to cover the antenna pattern to which the feed line is connected; and an external-glass-pane attachment step of attaching an external glass pane to an upper region of the adhesive layer in such a manner as to face outward from the vehicle. A second thickness of the adhesive layer may be greater than a first thickness of the antenna pattern.

According to an embodiment, the method may further include a feed line arrangement step of arranging the feed line on an upper region of the external glass pane through a lateral surface of the adhesive layer and a lateral surface of the external glass pane; and a cable connection step of connecting the other end portion of the feed line arranged on the upper region of the external glass pane to an RF cable.

According to an embodiment, in the method, the antenna patterns may be arranged on a transfer layer on the transfer substrate. The method may further include, before the mask pattern formation step, a transfer layer formation step of forming the transfer layer on the transfer substrate. The method may further include, after the mask pattern removal step: an antenna pattern transfer step of transferring the antenna patterns formed on the transfer substrate onto a glass pane intended to be installed in a vehicle; and a transfer substrate removal step of removing the transfer substrate from the glass pane onto which the antenna patterns are transferred.

According to an embodiment, the method may further include a transfer layer removal step of removing the transfer layer arranged on upper regions of the antenna patterns.

According to an embodiment, in the method, the glass pane may be a cover glass pane of a display panel. The method may further include: a feed line connection step of connecting one end portion of a feed line to one side of the antenna pattern; a first-adhesive-layer formation step of forming a first adhesive layer in such a manner as to cover the antenna pattern to which the feed line is connected; a touch sensor layer formation step of forming a touch sensor layer, on which a touch sensor is formed, on top of the first adhesive layer; a second-adhesive-layer formation step of forming a second adhesive layer on top of the touch sensor layer; and a display panel attachment step of attaching the display panel on top of the second adhesive layer.

According to an embodiment, in the method, the glass pane may be an external glass pane arranged to face outward from a building. The method may include: a feed line connection step of connecting one end portion of a feed line to one side of the antenna pattern; a spacer arrangement step of forming an adhesive layer in such a manner as to cover the antenna pattern to which the feed line is connected or arranging a spacer with a predetermined height in a peripheral region of the internal glass pane; and an internal-glass-pane attachment step of attaching an internal glass pane to an upper region of the spacer in such a manner as to face inward toward the interior of the building. A second thickness of the spacer may be greater than a first thickness of the antenna pattern.

According to an embodiment, in the method, the glass pane may be an internal glass pane arranged to face inward toward the interior of a building. The method may include: a feed line connection step of connecting one end portion of a feed line to one side of the antenna pattern; a spacer arrangement step of forming an adhesive layer in such a manner as to cover the antenna pattern to which the feed line is connected or arranging a spacer with a predetermined height in a peripheral region of the internal glass pane; and an external-glass-pane attachment step of attaching an external glass pane to an upper region of the spacer in such a manner as to face outward from the building. A second thickness of the spacer may be greater than a first thickness of the antenna pattern.

According to an embodiment, in the method, the antenna patterns may be formed, in an internal region of the antenna element, as metal mesh lines formed of a transparent conductive material, arranged along a first axis and a second axis orthogonal to the first axis. The metal mesh lines may have predetermined line widths W, and adjacent metal mesh lines along the first axis and the second axis may be spaced apart by a predetermined separation distance p. The antenna pattern may be formed as the metal mesh lines in such a manner as to have a first thickness of 1 μm or less.

According to an embodiment, in the method, the antenna pattern may include a first antenna pattern arranged in an upper central region of the glass pane of the vehicle and a second antenna pattern arranged in a lateral region. In the antenna pattern formation step, the first antenna pattern and the second antenna pattern may be simultaneously deposited on top of the glass pane of the vehicle. The first antenna pattern and the second antenna pattern may perform multiple input and multiple output (MIMO) operations by simultaneously transmitting or receiving a first wireless signal and a second wireless signal in the same frequency band.

According to an embodiment, in the method, the antenna pattern may include a first antenna pattern arranged in an upper central region of a front glass pane of the vehicle and a second antenna pattern arranged in a lateral region. In the antenna pattern formation step, the first antenna pattern may be deposited on a first transfer substrate, and the second antenna pattern may be deposited on a second transfer substrate. In the antenna pattern transfer step, the first antenna pattern formed on the first transfer substrate and the second antenna pattern formed on the second transfer substrate may be transferred onto the front glass pane of the vehicle. In the transfer substrate removal step, the first transfer substrate and the second transfer substrate may be removed from the front glass pane of the vehicle. The first antenna pattern and the second antenna pattern may perform multiple input and multiple output (MIMO) operations by simultaneously transmitting or receiving a first wireless signal and a second wireless signal in the same frequency band.

According to another aspect of the present disclosure, there is provided a transparent antenna module including a glass pane; and antenna patterns arranged on top of the glass pane in such a manner as to be spaced apart by a predetermined separation distance from each other, thereby radiating wireless signals. The antenna patterns are arranged to be positioned between mask patterns for antenna patterning. The mask patterns are removed from the top of the glass pane, and the antenna patterns are arranged on top of the glass pane in such a manner as to be spaced apart by a predetermined separation distance. According to an embodiment, in the transparent antenna module, the antenna patterns may form an antenna region radiating wireless signals. The mask pattern coupled to either of the outermost antenna patterns, among the antenna patterns, may be formed such that a first width thereof is greater than a second width of the mask pattern in the central portion of the antenna region. The mask patterns may be formed such that gaps between the mask patterns may decrease in the central portion of the antenna region, and thus, line widths of metal mesh lines, which correspond to widths of the antenna patterns positioned between the mask patterns, may increase in the central portion.

According to an embodiment, in the transparent antenna module, the glass pane may be an external glass pane arranged to face outward from a vehicle. The transparent antenna module may include: a feed line, one end portion of which is connected to one side of the antenna pattern and along which signals are transmitted to the antenna pattern; an adhesive layer arranged to cover the antenna pattern to which the feed line is connected; an internal glass pane arranged on an upper region of the adhesive layer in such a manner as to face inward toward the interior of the vehicle; and an RF cable connected, through soldering, to the other end portion of the feed line arranged through a lateral surface of the adhesive layer, a lateral surface of the internal glass pane, and an upper region of the internal glass pane. A second thickness of the adhesive layer may be greater than a first thickness of the antenna pattern.

According to an embodiment, in the transparent antenna module, the glass pane may be arranged to face inward toward the interior of a vehicle. The transparent antenna module may include: a feed line, one end portion of which is connected to one side of the antenna pattern and along which signals are transmitted to the antenna pattern; an adhesive layer arranged to cover the antenna pattern to which the feed line is connected; an external glass pane arranged on an upper region of the adhesive layer in such a manner as to face outward from the vehicle; and an RF cable connected, through soldering, to the other end portion of the feed line arranged through a lateral surface of the adhesive layer, a lateral surface of the external glass pane, and an upper region of the external glass pane. A second thickness of the adhesive layer may be greater than a first thickness of the antenna pattern.

According to an embodiment, in the transparent antenna module, the antenna patterns may be arranged on a transfer layer on a transfer substrate. The glass pane may be a glass pane of a vehicle, onto which the antenna patterns formed on the transfer substrate are transferred for arrangement thereon. The transfer substrate and the transfer layer may be removed from the glass pane of the vehicle, onto which the antenna patterns are transferred for arrangement thereon, and thus, the antenna patterns may remain on top of the glass pane of the vehicle, thereby being externally exposed.

### Advantageous Effects of Invention

The technical effects of a transparent antenna module according to the present disclosure and a method of manufacturing the transparent antenna module can be summarized as follows, without limiting the scope of the present disclosure.

The transparent antenna module according to the present disclosure features a structure that eliminates a user's perception of the boundary of the antenna and enables an antenna pattern to be directly formed on a glass pane of a product. Accordingly, when the transparent antenna module is mounted on the exterior of an application product equipped with communication functionality, the effects of avoiding degradation in communication performance and damage to exterior design can be achieved.

In addition, the structure of the antenna module, unlike that of a normal transparent antenna module, can eliminate the need for a substrate and a protective layer, thereby achieving the effect of reducing manufacturing costs.

The further scope of applicability of the present disclosure will become apparent from the following detailed description. However, various alterations and modifications to the present disclosure would be readily understood by a person of ordinary skill in the art without departing from the spirit and scope of the technical idea of the present disclosure. The detailed description and specific embodiments, such as preferred embodiments of the disclosure, should be understood as illustrative examples only.

### BRIEF DESCRIPTION OF DRAWINGS

FIG. 1 is a view illustrating structures in which an antenna pattern is formed on a transparent substrate.

FIG. 2 is a view illustrating a structure in which the antenna pattern is arranged on a glass pane according to the present disclosure.

FIG. 3 is a view illustrating the process of directly transferring a transparent antenna pattern according to the present disclosure onto the glass pane.

FIG. 4 is a view illustrating an embodiment in which the transparent antenna module according to the present disclosure is used within a double-layered glass pane for a vehicle.

FIG. 5 is a view illustrating an embodiment in which a transparent antenna according to the present specification is used within a display panel.

FIG. 6 is a view illustrating an embodiment in which the transparent antenna according to the present disclosure is formed within an exterior glass pane for a building.

FIG. 7 is a view illustrating an embodiment in which the transparent antenna according to the present disclosure is formed within an insulated glass pane that is a type of double-layered glass pane for a building.

FIG. 8 is a flowchart illustrating a method of manufacturing the transparent antenna according to the present disclosure.

FIG. 9 is a view illustrating the process of forming antenna patterns on top of the glass pane and the transparent antenna module manufactured by the process.

FIG. 10 is a flowchart illustrating the method of manufacturing the transparent antenna that uses the antenna patterns formed on a transfer substrate.

FIG. 11 is a view illustrating the process of forming the antenna patterns on the transfer substrate and the transparent antenna module manufactured by the process.

FIG. 12 is a view illustrating the structure of a vehicle in which the transparent antenna module according to the present disclosure is intended to be installed.

FIG. 13 is a view illustrating the structure of the transparent antenna module in which the antenna patterns that may be arranged in a double-layered glass pane structure for a vehicle are connected to a feed line.

FIG. 14 is a flowchart illustrating a method of manufacturing the transparent antenna module arranged on a display panel.

FIG. 15 is a flowchart illustrating the method of manufacturing the transparent antenna module arranged on an internal surface of an external glass pane or an internal glass pane for a building.

FIG. 16 is an enlarged view illustrating a metal mesh pattern formed in a specific antenna element and one region of the metal mesh pattern.

FIG. 17 is a view illustrating the transparent antenna module formed with multiple antenna structures in different regions of a front glass pane of the vehicle.

### MODE FOR THE INVENTION

Embodiments disclosed in the present specification will be described in detail below with reference to the accompanying drawings. The identical or similar constituent elements are represented by the same reference numerals, and redundant descriptions thereof are not omitted. The terms ‘module’ and ‘unit’ are hereinafter used interchangeably or separately to refer only to a constituent element for convenience of description in the present specification. They are not intended to imply different meanings or to depict different functions. In addition, when describing the embodiments disclosed in the present specification, a detailed description of a well-known related technology may be omitted if it is deemed that such a description would obscure the nature and gist of the present disclosure. In addition, the accompanying drawings are provided solely to facilitate understanding of the embodiments disclosed in the present specification. The technical idea disclosed in the present specification should not be construed as limited to the accompanying drawings. Furthermore, any alteration or equivalent of, or any substitute for, a constituent element according to an embodiment of the present disclosure, to the extent that it falls within the scope of the technical idea of the present disclosure, is intended to be encompassed within the scope of the present disclosure.

The ordinal numbers first, second, and so forth may be used to describe various elements, but they do not limit these elements. These terms are used solely to distinguish one element from another.

It should be understood that a constituent element, when referred to as ‘being connected to’ or ‘having access to’ a different constituent element, may be directly connected to or have direct access to the different constituent element, or may be indirectly connected to or have access to the different constituent element through one or more intermediate constituent elements. Likewise, it should be understood that a constituent element, when referred to as ‘directly connected to’ or ‘having direct access to’ a different constituent element, may be connected to or have access to the different constituent element without any intervening constituent element.

A noun in singular form, unless clearly indicated otherwise by the context, shall be understood to include the plural form.

The terms ‘include,’ ‘have,’ and equivalent expressions, as used in the present application, shall be understood to indicate the presence of a feature, number, step, operation, constituent element, component, or combination thereof, without precluding the possibility of the presence or addition of one or more other features, numbers, steps, operations, constituent elements, components, or combinations thereof.

Examples of electronic equipment mentioned in the present specification may include a portable phone, a smartphone, a laptop computer, a digital broadcast terminal, a personal digital assistant (PDA), a portable multimedia player (PMP), a navigation device, a slate PC, a tablet PC, an ultrabook PC, a wearable device (i.e., a watch-type terminal, a smart-type terminal, or a head-mounted display (HMD)), and the like.

However, except when a configuration according to an embodiment described in the present specification is limited to application to a mobile terminal, it would be understood by a person of ordinary skill that such a configuration is also applicable to a stationary terminal, such as a digital TV, a desktop computer, digital signage, or a robot.

A transparent antenna module according to the present disclosure and a method of manufacturing the transparent antenna module will be described in detail below. Recent wireless communication technology enables ultra-high-speed and large-capacity data communication. Achieving such communication performance requires the use of higher frequency. This means that as progress is made from the currently most-used 4G LTE communication toward 5G, 6G, and beyond, the frequency employed in communication increases. As the communication frequency increases, there are advantages such as enhanced communication performance and quality in terms of transmission speed and the volume of data transmitted or received. However, there are also disadvantages such as shorter communication distances and increased signal interference. Therefore, to fully leverage the advantages of high-frequency communication, many additional technologies are required.

For example, 5G communication requires more repeaters than 4G communication to compensate for short transmission and reception distances, which are drawbacks of high-frequency communication. In addition, an antenna for transmitting and receiving communication signals is required to be installed at a location that is free from obstruction by surrounding obstacles. In addition, low-loss materials are required to be used in high-frequency communication components, including antennas, in order to reduce signal loss. The loss in materials due to the frequency of a high-frequency signal is defined in Equation 1.

$${IG}_{loss =} f \sqrt{ε} , {diel}_{loss} \qquad Equation 1$$

Signal loss (SIGₗₒₛₛ) is proportional to the frequency (f), the square root of the dielectric constant (ε), and dielectric loss (dielₗₒₛₛ). In Equation S1, the dielectric constant (ε) and dielectric loss (dielₗₒₛₛ) are intrinsic values associated related to the dielectric properties of a material used in a high-frequency communication component. In addition, it is advantageous to attach an antenna for high-frequency communication to the exterior of a product rather than to install it within the product, in order to prevent interference such as blocking, absorption, or loss of radio waves caused by the exterior casing, the chassis, or the like of the product.

The trend in recent products requiring communication functionality, such as mobile devices, TVs, and vehicles, is toward satisfying both premium performance and unique design in a desirable manner. From the perspective of communication functionality, as described above, a high-frequency communication functionality operating in a higher frequency band is required to be incorporated into the product to enhance overall communication performance. However, in keeping with recent trends toward sophisticated and innovative product design, a tendency has emerged to avoid attaching various components to the exterior of the product. A transparent antenna is a technology designed to satisfy the requirements for both high-performance communication and unobtrusive product design. The transparent antenna can be installed on the exterior of the product to minimize loss of high-frequency communication signals and to reduce interference from surrounding obstacles. In addition, the transparent antenna for high-frequency communication serves the dual purpose of leaving the exterior design of the product unchanged and remaining visually imperceptible to the user.

The transparent antenna module according to the present disclosure may be arranged on a display of the electronic device described above. FIG. 1 is a view illustrating structures in which an antenna pattern is formed on a transparent substrate. The transparent antenna module has a structure in which antenna patterns 1100, which function as conductors, are formed on a transparent substrate 1010a formed of a transparent material or on a predetermined region of the transparent substrate 1010a. A feed line capable of transmitting/receiving signals to/from the antenna patterns 1100 and a protective layer 1040 for protecting the antenna patterns 1100 may be formed on the transparent antenna module.

The transparent substrate is formed of a material with high transmissivity and a low dielectric constant to ensure transparency and minimize loss of high-frequency signals, respectively. As the transparent material for the transparent substrate 1010a, PET and COP may be used. The antenna pattern needs to be designed according to the frequency to transmit or receive high-frequency communication signals. In this regard, as the communication frequency increases, the corresponding wavelength becomes shorter, and accordingly, the size of the antenna pattern also decreases proportionally. The antenna is formed of a conductive material because its function is to transmit and receive radio waves. Typically, the antenna is formed of a metal material such as Cu or Ag. Because most metallic materials are not transparent in the visible light range, the metal antenna pattern is formed in the shape of a metal mesh or a metal grid. The purpose of the shape of a metal mesh or a metal grid is to form a transparent conductive pattern with a fine line width that reduces visibility, thereby rendering the pattern visually imperceptible to the user. In addition, the protective layer 1040 is formed on top of the antenna patterns 1100 to protect the antenna patterns 1100. The protective layer 1040 may be formed of a high-transmissivity material such as PET.

The transparent antenna module configured as described above is substantially visually imperceptible to the user due to the high transmissivity of the material and the antenna pattern. However, when the transparent antenna module is actually mounted on the exterior of a product such as a glass pane for a vehicle, a glass pane for a building, or a front display panel, the outline of the terminal portion of the transparent antenna module is visually discernible. This visual discernibility does not result from the transmissivity of the antenna itself, but rather from the outline of the terminal portion of the transparent antenna module, which becomes visible due to the boundary of the material of the substrate, the protective layer, or a similar component used in the module. This is because the outer boundary of the material is defined by the limited area of the substrate, the pattern, or the protective layer, and the outline of this end is inevitably visually perceptible to the user.

According to the present disclosure, to address these problems, an antenna pattern is directly formed on a glass surface of a product on which the antenna pattern is to be formed, without the use of a transparent substrate or a protective layer in the transparent antenna module. Accordingly, the visibility caused by the outer boundary of the substrate or the protective layer is eliminated. A borderless transparent antenna is realized by forming an antenna pattern within a double-layered glass pane for a vehicle or on one internal side of a display panel.

In the transparent antenna module in (a) of FIG. 1, the antenna patterns 1100 are formed on top of the transparent substrate 1010a. The protective layer 1040 may be arranged on upper regions of the antenna patterns 1100 to protect the antenna patterns 1100. In the transparent antenna module in (b) of FIG. 1, structures 1100b for forming the antenna patterns 1100 are formed on top of the transparent substrate 1010a as engravings in the shapes of the antenna patterns 1100. The antenna patterns 1100 are formed between the structures 1100b. The protective layer 1040 may be placed on upper regions of the antenna patterns 1100 and upper regions of structures 1100b to protect the antenna patterns 1100.

The transparent antenna module in FIG. 1 has outer boundaries defined by the areas of the structures 1100b or the like surrounded by the transparent substrate 1010a, the protective layer 1040, and the antenna patterns 1100. Therefore, even if each layer is formed of a transparent material and the structures 1100b are thinly formed, the presence of the transparent antenna module appears visible.

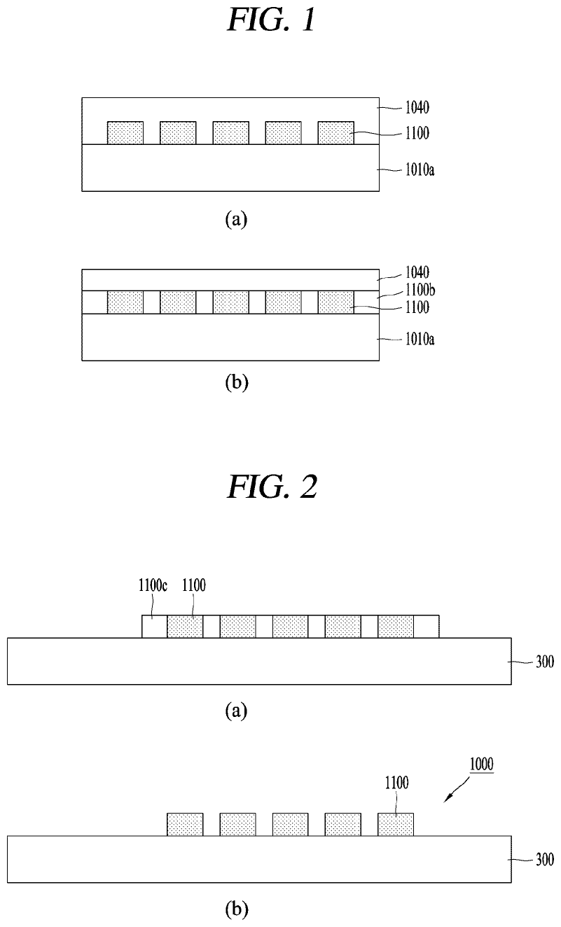

The transparent antenna according to the present invention has a structure in which the antenna pattern is directly formed on the glass surface of the product on which the antenna pattern is to be formed. In this regard, FIG. 2 is a view illustrating a structure in which the antenna pattern is arranged on a glass pane according to the present disclosure. With reference to (a) of FIG. 2, mask patterns 1100c may be formed, spaced apart from each other, on an upper region of a glass pane 300. The antenna patterns 1100 are formed on the glass pane 300 such that the antenna patterns 1100 are positioned between the mask patterns 1100c.

(b) of FIG. 2 illustrates that the antenna patterns 1100 are arranged on the upper region of the glass pane 300 without the use of a transparent substrate or a separate structure. To this end, the mask patterns 1100c may be removed from the glass pane 300 such that only the antenna patterns 1100 remain on top of the glass pane 300. At this point, the glass pane 300 is assumed to form part of a product on which the transparent antenna is to be formed, such as a glass pane for a vehicle, a front glass pane of a display, or a glass pane for a building.

The process of manufacturing the transparent antenna according to the present disclosure may also apply to a display panel or a similar component of a compact electronic device, such as a mobile device. The antenna pattern may be directly formed on one surface of a glass pane used in an electronic device by performing a physical or chemical deposition that employs an antenna pattern mask or by performing a printing method. In a case where the product on which the transparent antenna is to be formed, such as a glass pane for a vehicle or a glass pane for a building, has a large size, the antenna pattern is first formed on a transfer substrate by performing the process described above. Subsequently, the antenna pattern is transferred onto and attached to the glass pane of the product on which the antenna is to be formed.

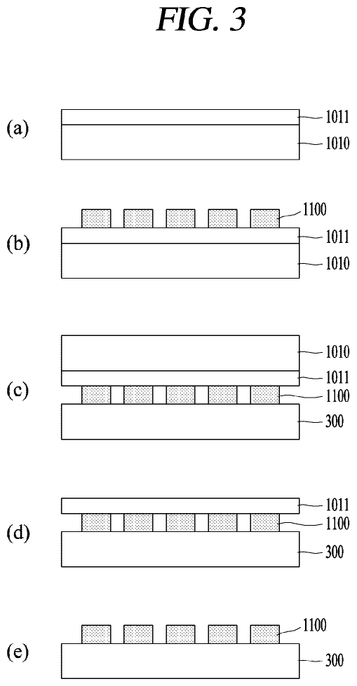

FIG. 3 is a view illustrating the process of directly transferring the transparent antenna pattern according to the present disclosure onto the glass pane. As illustrated in (a) of FIG. 3, a transfer substrate 1010 is prepared and an adhesive layer 1020, which is easily removable, is formed on top of the transfer substrate 1010. Subsequently, as illustrated in (b) of FIG. 3, the antenna patterns 1100 are formed on top of the adhesive layer 1020 by performing the method described above. Subsequently, as illustrated in (c) of FIG. 3, the antenna patterns 1100 are transferred onto a glass substrate 300 to be formed. The antenna patterns 1100 are transferred onto the glass substrate 300, and then the transfer substrate 1010 and adhesive layer 1020 are removed. At this point, to transfer and attach the antenna patterns 1100 onto the glass pane 300, another adhesive layer may also be formed in advance on the glass pane 300.

To transfer the antenna patterns 1100 from the transfer substrate 1010 to the glass pane 300, the adhesive force between the antenna patterns 1100 and the adhesive layer 1020 formed on the transfer substrate 1010 should be low. Specifically, the adhesive force between the antenna patterns 1100 and the adhesive layer 1020 should be lower than the adhesive force between the glass pane 300 and the antenna patterns 1100. Alternatively, the adhesive layer 1020 may be used so that the adhesive force between the transfer substrate 1010 and the adhesive layer 1020 is lower than the adhesive force between the glass pane 300 and the antenna patterns 1100. Both the adhesive layer 1020 and the antenna patterns 1100 may also be transferred from the transfer substrate 1010 to the glass pane 300.

At this point, as illustrated in (d) of FIG. 3, the adhesive layer 1020 transferred along with the antenna patterns 1100 on the glass pane 300 should be removed. Subsequently, as illustrated in (e) of FIG. 3, the antenna patterns 1100 may be directly formed on the glass pane 300 of the final product on which the transparent antenna is to be formed. A PET film substrate or an ordinary glass pane may be used as the transfer substrate 1010. In addition, the adhesive layer 1020 used in the transfer process may be formed as a thermal release film, a laser release film, or a similar film.

However, the method of forming the antenna pattern, the method of transferring the antenna pattern, the material of the adhesive layer, and similar components are described as illustrative examples in the present specification, and therefore, the transfer technology according to the present disclosure is not limited thereto. The antenna pattern is formed of a metallic material with high conductivity. For example, the antenna pattern is formed of Ag, Cu, Al, Au, or the like. At this point, the antenna pattern may be formed in the shape of a metal mesh with narrow line width and wide line spacing to remain visually imperceptible to the user. In addition to being formed of a metallic material in the shape of a mesh, the antenna pattern may be formed of a transparent conductive material. Transparent conductive materials, unlike metallic materials, are characterized by both transmissivity and conductivity that meet or exceed predetermined values. Therefore, the transparent antenna may be formed without being in the shape of a mesh.

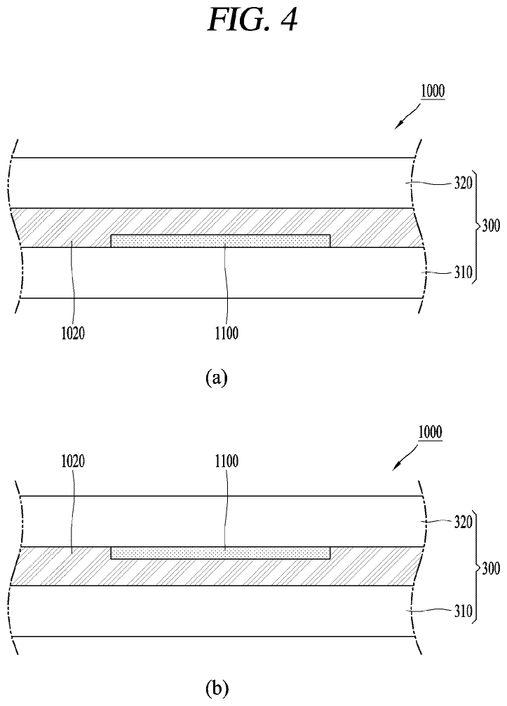

FIG. 4 is a view illustrating an embodiment in which the transparent antenna module according to the present disclosure is formed within the double-layered glass pane for a vehicle. The double-layered glass pane for a vehicle may be manufactured to include a structure in which an external glass pane 320 and an internal glass pane 310 overlap. The double-layered glass pane for a vehicle is manufactured by applying an adhesive 1020 between the external glass pane 320 and the internal glass pane 310 and boding them together. Polyvinyl Butyral (PVB) may be used as the adhesive 1020 for bonding two glass panes together. However, the adhesive S1020 is not limited thereto, and other adhesives may be used depending on the intended application.

In the transparent antenna module in (a) of FIG. 4, the antenna pattern 1100 may be directly formed on an internal surface of the internal glass pane 310 of the double-layered glass pane 300. In the transparent antenna module in (b) of FIG. 4, the antenna pattern 1100 may be directly formed on an internal surface of the external glass pane 320 of the double-layered glass pane 300. The antenna pattern 1100, formed of a transparent material, is used as a metal conductor and thus has the shape of a mesh to remain visually imperceptible to the user. The antenna pattern 1100 may be set to have a line width of 2 to 5 μm, and a pitch of 70 to 150 μm. However, the antenna pattern S1100 is not limited thereto, and the width and the pitch may vary depending on the intended application. The antenna pattern S1100 may be directly formed on a glass pane for a vehicle without the use of the transparent substrate for forming the antenna pattern 1100. Thus, the visibility problem associated with the outer boundary of a transparent substrate for an antenna can be eliminated.

As described above, the adhesive 1020, such as PVB, is used to bond the internal glass pane and the external glass pane to manufacture the double-layered glass pane for a vehicle. Therefore, as illustrated in the structure in FIG. 4, since the antenna pattern 1100, formed of a transparent material, is positioned between the internal surface of the internal glass pane 310 or the external glass pane 320 and the adhesive 1020, the adhesive 1020 serves to protect the antenna pattern 1100. Therefore, the visibility problem associated with the outer region caused by a pattern protective layer used in the transparent antenna can also be addressed without the use of a separate pattern protective layer. According to the present disclosure, the antenna pattern 1100 is designed to have a thickness of 0.5 μm to 2 μm. The layer of the antenna pattern can have a smaller thickness than the glass pane 300 or the adhesive 1020, thereby addressing the visibility problem associated with the antenna pattern.

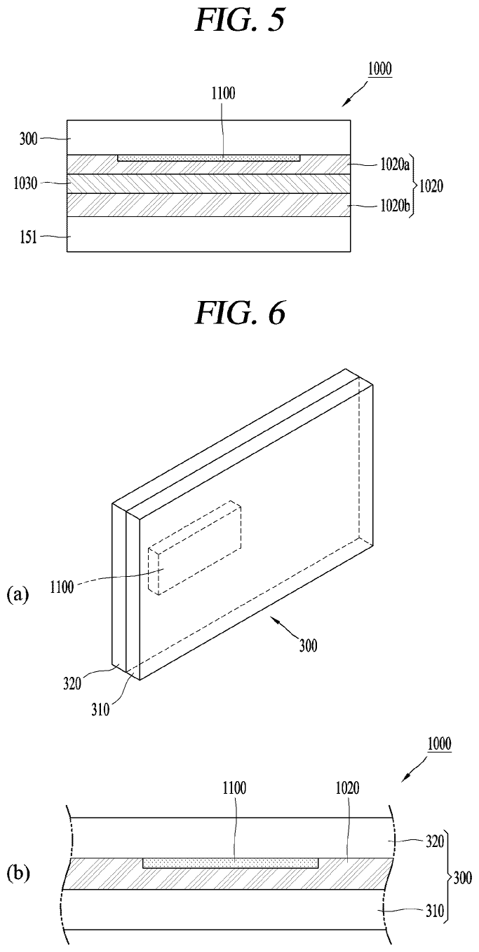

FIG. 5 is a view illustrating an embodiment in which the transparent antenna according to the present specification is formed within a display panel. A display panel included in a product such as a smartphone, a laptop computer, and a monitor typically includes an LCD or an OLED display unit, and a front cover glass pane, and may further a touch sensor unit depending on the product's functionality. FIG. 5 illustrates the basic structure of a display panel 151 of an electronic device, such as a smartphone, which includes a touch sensor.

The touch sensor is typically placed on top of an LCD or an OLED, and an optical adhesive (OCA) is stacked on the touch sensor. A cover glass pane 300 for pattern protection is provided on the outside of a display. The cover glass pane S300 may be formed of a glass pane or an optical PET film. The cover glass pane 300 may be adhered to the touch sensor using the adhesive layer 1020 such as OCA.

In this regard, the transparent antenna module used in the display panel may include the cover glass pane 300, the antenna pattern 1100, a first adhesive layer 1020a, a touch sensor layer 1030, a second adhesive layer 1020b, and a display panel 151.

The antenna pattern 1100 as illustrated in FIGS. 2 and 3, may be formed on the cover glass pane 300. The first adhesive layer 1020a may be formed to cover the antenna pattern 1100. The touch sensor layer 1030, which includes the touch sensor, may be formed on top of the first adhesive layer 1020a. The second adhesive layer 1020b may be formed on the touch sensor layer 1030. The display panel 151 may be arranged on top of the second adhesive layer 1020b.

In a case where the transparent antenna realized by the antenna pattern 1100 is used in a structure that includes the display panel 151, the antenna pattern 1100 may be formed within the cover glass pane 300. Alternatively, the antenna pattern S1100 can be formed at any position on top of the touch sensor layer 1030. A metal region of the touch sensor layer 1030 may function as a ground for the antenna pattern 1100. The touch sensor layer 1030 and the first adhesive layer 1020a also serve as protective layers for the antenna pattern 1100, without the use of either a separate substrate material for the transparent antenna or a separate pattern protective layer. Thus, the visibility problem caused by the boundary can be addressed.

High-frequency communication signals, such as those in 5G, have strong directivity, but they have the disadvantage of short reach due to signal loss caused by obstacles, necessitating the installation of repeaters at appropriate intervals. In particular, to transmit high-frequency signals from outside a building to the inside, it is necessary to provide an appropriate means for effectively transmitting the signals between indoors and outdoors without loss, because signal loss occurs due to the building's exterior walls or windows. A double-layered glass pane for a building is formed by bonding two glass panes together using an adhesive.

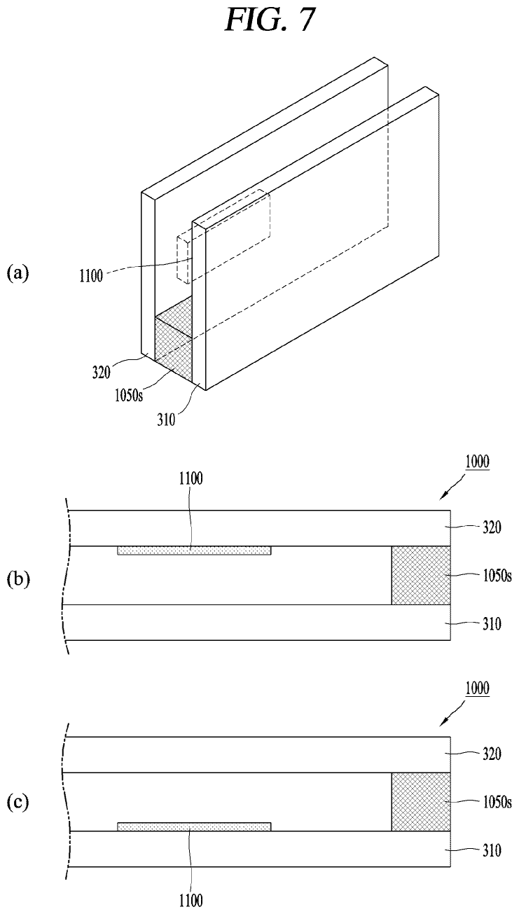

In this regard, FIG. 6 is a view illustrating an embodiment in which the transparent antenna according to the present disclosure is formed within an exterior glass pane for a building. FIG. 7 is a view illustrating an embodiment in which the transparent antenna according to the present disclosure is formed within an insulated glass pane that is a type of double-layered glass pane for a building.

With reference to (a) of FIG. 6, the antenna pattern 1100, which serves as the transparent antenna, may be arranged between the internal glass pane 310 and the external glass pane 320 of the double-layered glass pane for a building. With reference to (b) of FIG. 6, the antenna pattern 1100 may be arranged on the external glass pane 320. The adhesive layer 1020 may be positioned between the external glass pane 320 and the external glass pane 310 to cover the antenna pattern 1100 arranged on top of the external glass pane 320.

With reference to FIG. 6, the antenna pattern 1100 is formed on the internal surface of the external glass pane 320. The antenna pattern 1100 may also be formed on the internal surface of the internal glass pane 310. The antenna pattern 1100 formed on the internal surface of the external glass pane 320 or the internal glass pane 310 may be protected by the adhesive 1020 that bonds glass panes together.

With reference to (a) of FIG. 7, the antenna pattern 1100, which serves as the transparent antenna, may be arranged between the internal glass pane 310 and the external glass pane 320 of the insulated glass pane for a building. A spacer 1050s may be arranged in a peripheral region between the internal glass pane 310 and the external glass pane 320. (b) of FIG. 7 illustrates a structure in which the antenna pattern 1100 is arranged on the internal surface of the external glass pane 320 that forms part of the insulated glass pane for a building. (c) of FIG. 7 illustrates a structure in which the antenna pattern 1100 is positioned on the internal surface of the internal glass pane 310 that forms part of the insulated glass pane for a building.

With reference to FIG. 7, the insulated glass pane has a structure in which the spacer 1050s is placed between the external glass pane 320 and the internal glass pane 310, thereby forming an air layer 1050 that enhances the thermal insulation effect. When forming the antenna pattern 1100 on the insulated glass pane, as illustrated in (b) or (c) of FIG. 7, the antenna pattern 1100 is formed on the internal surface of the external glass pane 320 or the internal glass pane 310. Structurally, the internal surface of the insulated-glass pane is not exposed to external contamination or physical damage. Accordingly, there is no need to additionally form a protective layer for protecting the antenna pattern 1100.

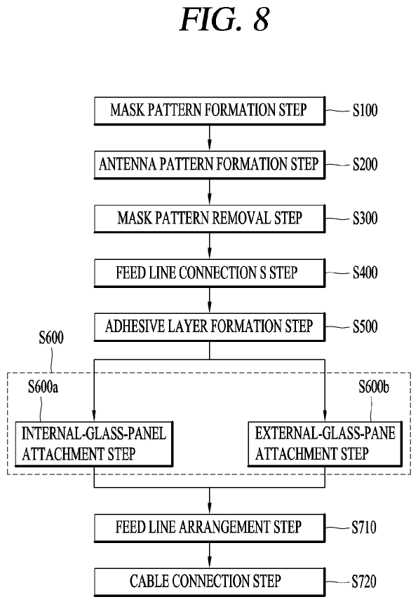

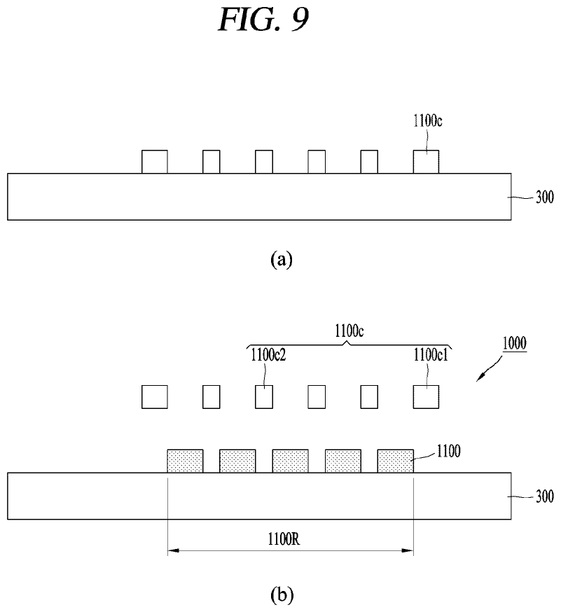

A method of manufacturing the transparent antenna according to the present disclosure and a transparent antenna manufactured using the method are described with reference to the transparent antenna module in FIGS. 2 to 7. In this regard, FIG. 8 is a flowchart illustrating the method of manufacturing the transparent antenna according to the present disclosure. FIG. 9 is a view illustrating the process of forming the antenna patterns on top of the glass pane and the transparent antenna module manufactured by the process.

With reference to FIG. 8 and (a) of FIG. 9, the mask patterns 1100c for antenna patterning on top of the glass pane 300 may be formed in a mask pattern formation step S100 of the method of manufacturing the transparent antenna. The mask patterns 1100c may be arranged to be spaced apart from each other along one axial direction. The mask patterns 1100c may be formed in such a manner as to have resin structures, but they are not limited thereto. However, the mask patterns 1100c may have other structures depending on the intended application. The mask patterns may be formed to have different widths along one axis, in view of the deposition or transfer process and the mask pattern removal process.

With reference to FIG. 8 and (b) of FIG. 9, in an antenna pattern formation step S200 of the method of manufacturing the transparent antenna, the antenna patterns 1100 may be formed on top of the glass pane 300 such that the antenna patterns 1100 are positioned between the mask patterns 1100c. In a mask pattern removal step S300 of the method of manufacturing the transparent antenna, the mask patterns 1100c may be removed from the top of the glass pane 300 such that only the antenna patterns 1100 remain on top of the glass pane 300.

In the mask pattern removal step S300, the widths along one axis of the mask patterns 1100c may be set to differ from one another, taking into consideration the force applied to the mask patterns 1100c and the extent of deformation of the antenna patterns 1100. Either of the outermost mask patterns, among the mask patterns 1100c, may be formed such that a first width thereof is greater than a second width of the central mask pattern. The antenna patterns 1110 form an antenna region 1100R that radiates wireless signals. A mask matter 1100c1 coupled to either of the outermost antenna patterns, among the antenna patterns 1110, may be formed such that a first width thereof is greater than a second width of a mask pattern 1100c2 in the central portion of the antenna region 1100R.

The mask patterns 1100c may be formed such that gaps between adjacent mask patterns 1100c are uniform. Accordingly, metal mesh lines may be formed such that the line widths thereof, corresponding to the widths of the antenna patterns 1100 formed between the mask patterns 1100c, are uniform. Accordingly, within the antenna area 1100R on top of the glass pane 300, uniform visibility between the antenna patterns 1100 may be maintained. In this regard, to reduce dielectric regions adjacent to the antenna region 1100R, dummy metal mesh lines may be arranged in the adjacent dielectric regions. The dummy metal mesh lines may be formed such that first line widths thereof are smaller than second line widths of the antenna patterns 1100.

Adjacent mask patterns 1100c may be formed such that gaps between the adjacent mask patterns S1100c decrease in the central portion. Accordingly, the line widths of the metal mesh lines, corresponding to the widths of the antenna patterns 1100 formed between the mask patterns 1100c, increase in the central portions. The antenna region 1100R may be formed such that first line widths of one end portion and the other end portion thereof are smaller than a second central portion of the antenna region 1100R. Accordingly, the visibility difference between the end portion of the antenna region 1100R and the dielectric region adjacent to the end portion can be reduced on top of the glass pane 300. In this structure, separate dummy metal mesh lines do not need to be arranged in the dielectric region adjacent to the antenna region 1100R.

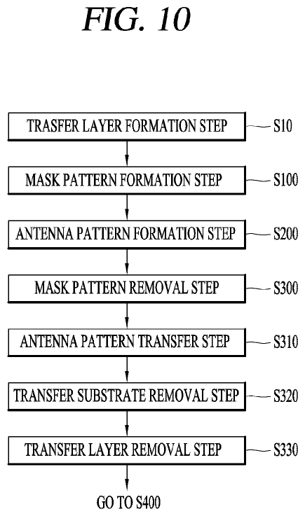

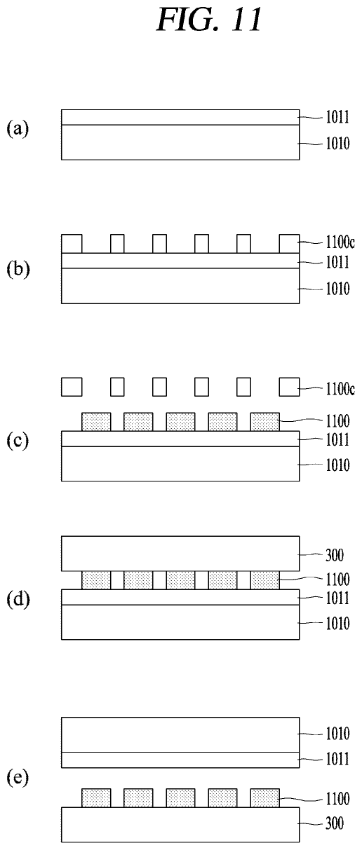

The transparent antenna according to the present disclosure and the method of manufacturing the transparent antenna may be configured such that the antenna patterns formed on the transfer substrate are transferred onto the top of the glass pane. In this regard, FIG. 10 is a flowchart illustrating the method of manufacturing a transparent antenna that uses the antenna patterns formed on the transfer substrate. FIG. 11 is a view illustrating the process of forming the antenna patterns on the transfer substrate and the transparent antenna module manufactured by the process.

With reference to FIG. 10 and (a) of FIG. 11, a transfer layer 1011 may be formed on the transfer substrate 1010. With reference to FIGS. 8 and 10 and (b) of FIG. 11, in the mask pattern formation step S100 of the method of manufacturing the transparent antenna, the antenna patterns 1100 may be formed on the transfer layer 1011 on the transfer substrate 1010 such that the antenna patterns 1100 are positioned between the mask patterns 1100c.

With reference to FIGS. 8 and 10 and (a) of FIG. 11, in the mask pattern removal step S300 of the method of manufacturing the transparent antenna, the mask patterns 1100c may be removed from the transfer layer 1011 such that only the antenna patterns 1100 remain on the transfer layer 1011. With reference to FIGS. 8 and 10 and (d) of FIG. 11, in an antenna pattern transfer step S310 of the method of manufacturing the transparent antenna, the antenna patterns 1100 formed on the transfer substrate 1010 may be transferred onto the glass pane 300, which is intended to be installed in a vehicle.

With reference to FIGS. 8 and 10 and (e) of FIG. 11, in a transfer substrate removal step S320 of the method of manufacturing the transparent antenna, the transfer substrate 1010 may be removed from the glass pane 300 onto which the antenna patterns 1100 are transferred. In addition, in a transfer layer removal step S330, the transfer layer 1011 arranged on upper regions of the antenna patterns 1100. In this regard, after turning over the glass pane 300 and the transfer substrate 1010 in the opposite direction and arranging them, the transfer substrate removal step S320 and the transfer layer removal step S330 may be performed.

With reference to FIGS. 2 to 11, the method of manufacturing the transparent antenna may include the mask pattern formation step S100, the antenna pattern formation step S200, and the mask pattern removal step S300. In the mask pattern formation step S100, the mask patterns 1100c for antenna patterning on top of the glass pane 300 or the transfer substrate 1010 may be formed. The mask patterns 1100c may be removed after the antenna patterning is performed on the top of the glass pane 300 or the transfer substrate 1010.

In the antenna pattern formation step S200, the antenna patterns 1100 may be formed on top of the glass pane 300 or the transfer substrate 1010 such that the antenna patterns 1100 are positioned between the mask patterns 1100c. In the mask pattern removal step S300, the mask patterns 1100c may be removed from the top of the glass pane 300 or the transfer substrate 1010 such that the only the antenna patterns 1100 remain on top of the glass pane 300 or the transfer substrate 1010.

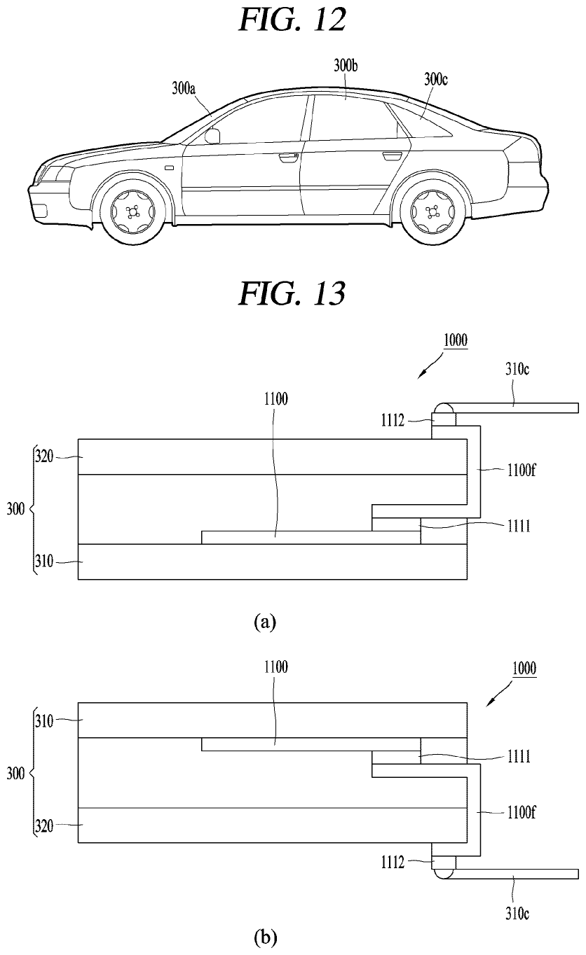

FIG. 12 is a view illustrating the structure of a vehicle in which the transparent antenna module according to the present disclosure is intended to be installed. FIG. 13 is a view illustrating the structure of the transparent antenna module in which the antenna patterns that may be arranged in a double-layered glass pane structure for a vehicle are connected to a feed line.

(a) of FIG. 13 illustrates a structure in which a feed line 1100f is connected in a state in which the antenna pattern 1100 of the transparent antenna is arranged on the internal surface of the internal glass pane 310. (a) of FIG. 13 illustrates a structure in which a feed line 1100f is connected in a state in which the antenna pattern 1100 of the transparent antenna is arranged on the internal surface of the external glass pane 320. With reference to FIG. 13, the antenna pattern 1100 is connected to one end portion of the feed line 1100f through a first coupling portion 1111 by anisotropic conductive film (ACF) bonding. The other end portion of the feed line 1100f is connected to an RF cable 310c through the second coupling portion 1112 by soldering. One end portion of the antenna pattern 1100 may be coupled to one end portion of the feed line 1100f formed on top of an FPCB, thereby forming the first coupling portion 1111. The other end portion of the feed line 1100f formed on top of the FPCB may be coupled to an internal conductor of the RF cable 310c, thereby forming the second coupling portion 1112.

With reference to FIGS. 2 to 13, the glass pane 300 may be a front glass pane 300a of a vehicle, a side glass pane 300b thereof, or a quarter glass pane 300c thereof that is arranged in a second region in a manner that is adjacent to a first region in which the side glass pane 300b is arranged. The second region in which the quarter glass pane 300c is arranged can be formed to be narrower than the first region in which the side glass pane 300b is arranged. The front glass pane 300a and the side glass pane 300b may be formed such that the size of the front glass pane 300a is greater than the size of the side glass pane 300b. The side glass pane 300b and the quarter glass pane 300c may be formed such that the size of the side glass pane 300b is greater than the size of the quarter glass pane 300c.

The glass pane 300 may be an external glass pane 320 arranged to face outward from the vehicle. A method of manufacturing the transparent antenna module may include a feed line connection step S400, an adhesive layer formation step S500, and a glass pane attachment step S600. When the antenna pattern 1100 is arranged on the external glass pane 320, the glass pane attachment step S600 may be an internal-glass-pane attachment step S600a.

In the feed line connection step S400, one end portion of the feed line 1100f may be connected to one end portion of the antenna pattern 1100. In the adhesive layer formation S500, the adhesive layer 1020 may be formed to cover the antenna pattern 1100 to which the feed line 1100f is connected. In the internal-glass-pane attachment step S600a, the internal glass pane 310, which is arranged to face inward toward the interior of the vehicle, may be attached to an upper region of the adhesive layer 1020. The adhesive layer 1020 may be formed such that a second thickness thereof is greater than a first thickness of the antenna pattern 1100. Accordingly, the adhesive layer 1020 may secure the antenna pattern 1100 to a specific position on the glass pane while also covering the antenna pattern 1100 for protection.

The method of manufacturing the transparent antenna module may further include a feed line arrangement step S710 and a cable connection step S720. In the feed line arrangement step S710, the feed line 1100f may be arranged on an upper region of the internal glass pane 310 through a lateral surface of the adhesive layer 1020 and a lateral surface of the internal glass pane 310. In the cable connection step S720, the other end portion of the feed line 1020 arranged on the upper region of the internal glass pane 310 may be connected to the RF cable 310c.

The glass pane 300 may be the internal glass pane 310 arranged to face outward from the vehicle. When arranging the antenna pattern 1100 on the internal glass pane 310, the glass pane attachment step S600 may be an external-glass-pane attachment step S600b.

In the feed line connection step S400, one end portion of the feed line 1100f may be connected to one side of the antenna pattern 1100. In the adhesive layer formation S500, the adhesive layer 1020 may be formed to cover the antenna pattern 1100 to which the feed line 1100f is connected. In the external-glass-pane attachment step S600b, the external glass pane 320, which is arranged to face outward from the vehicle, may be attached to the upper region of the adhesive layer 1020. The adhesive layer 1020 may be formed such that the second thickness thereof is greater than the first thickness of the antenna pattern 1100. Accordingly, the adhesive layer 1020 may secure the antenna pattern 1100 to a specific position on the glass pane while also covering the antenna pattern 1100 for protection.

In the feed line arrangement step S710, the feed line 1100f may be arranged on an upper region of the external glass pane 320 through a lateral surface of the adhesive layer 1020 and a lateral surface of the external glass pane 320. In the cable connection step S720, the other end portion of the feed line 1020 arranged on the upper region of the external glass pane 320 may be connected to the RF cable 310c.

The antenna patterns 1100 of the transparent antenna module may be arranged on the transfer layer 1011 on the transfer substrate 1010. In this regard, FIG. 9 illustrates the method of manufacturing the transparent antenna module manufactured by a transfer technique. With reference to FIGS. 2 to 9, the method of manufacturing the transparent antenna may further include, before the mask pattern formation step S100, a transfer layer formation step S10. In the transfer layer formation step S10, the transfer layer 1011 may be formed on top of the transfer substrate 1010. The method of manufacturing the transparent antenna may further include, after the mask pattern removal step S300, the antenna pattern transfer step S310, the transfer substrate removal step S320, and the transfer layer removal step S330.

In the antenna pattern transfer step S310, the antenna patterns 1100 formed on the transfer substrate 1010 may be transferred onto the glass pane 300, which is intended to be installed in a vehicle. In the transfer substrate removal step S320, the transfer substrate 1010 may be removed from the glass pane 300 onto which the antenna patterns 1100 are transferred. In the transfer layer removal step S330, the transfer layer 1011 arranged on the upper regions of the antenna patterns 1100 may be removed.

When the antenna patterns 1100, as illustrated in FIG. 9, are formed on top of the glass pane 300 by a deposition method, the transfer layer formation step S10, the antenna pattern transfer step S310, the transfer substrate removal step S320, and the transfer layer removal step S330, which are illustrated in FIG. 10, may be omitted. Therefore, when the antenna patterns 1100, as illustrated in FIG. 11, are formed on top of the glass pane 300 by a transfer method, the transfer layer formation step S10, the antenna pattern transfer step S310, the transfer substrate removal step S320, and the transfer layer removal step S330, which are illustrated in FIG. 10, may be further performed.

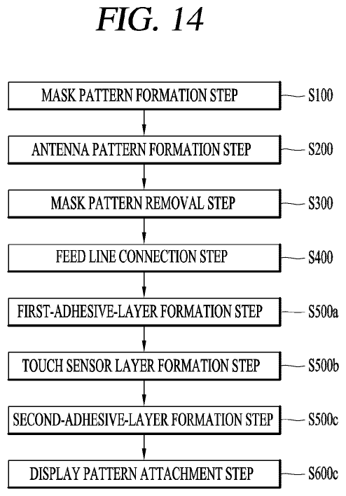

When the front glass pane of a vehicle meets or exceeds a predetermined size and thus cannot be placed on a deposition apparatus, a method of transferring the antenna pattern may be performed. When the front glass pane of a vehicle falls below the predetermined size, a method of depositing the antenna pattern may be performed. As illustrated in FIG. 5, the glass pane 300 may be the cover glass pane 300 of the display panel. In this regard, FIG. 14 is a flowchart illustrating the method of manufacturing the transparent antenna module arranged on the display panel. With reference to FIGS. 2 to 7 and FIGS. 8 and 14, the method of manufacturing the transparent antenna may further include the feed line connection step S400, a first-adhesive-layer formation step S500a, a touch sensor layer formation step S500b, a second-adhesive-layer formation step S500c, and a display panel attachment step S600c.

In the feed line connection step S400, one end portion of the feed line 1100f may be connected to one side of the antenna pattern 1100. In the first-adhesive-layer formation step S500a, the first adhesive layer 1020a may be formed to cover the antenna pattern 1100 to which the feed line 1100f is connected. In the touch sensor layer formation step S500b, the touch sensor layer 1030 on which the touch sensor is formed may be formed on top of the first adhesive layer 1020a. In the second-adhesive-layer formation step S500c, the second adhesive layer 1020b may be formed on the touch sensor layer 1030. In the display panel attachment step S600c, the display panel 151 may be attached on top of the second adhesive layer 1020b.

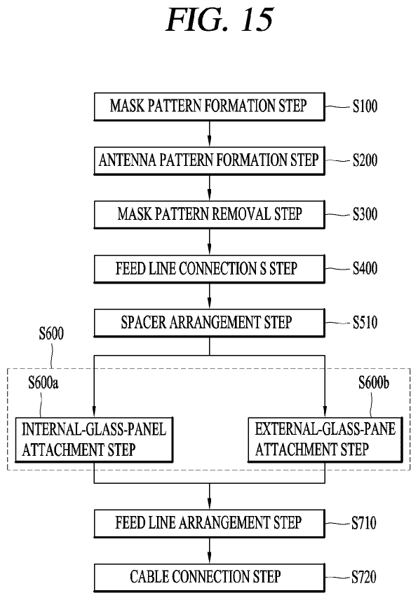

The transparent antenna module according to the present disclosure, as illustrated in FIGS. 6 and 7, may be mounted on the glass pane 300 for a building. In this regard, FIG. 15 is a flowchart illustrating the method of manufacturing the transparent antenna module arranged on the internal surface of the external glass pane or the internal glass pane for a building.

With reference to FIGS. 2 to 7 and FIGS. 8 and 15, the glass pane 300 may be the external glass pane 320 arranged to face outward from the building. The method for manufacturing the transparent antenna module may further include the feed line connection step S400, a spacer arrangement step S510, and the glass pane attachment step S600. When the antenna pattern 1100 is arranged on the external glass pane 320, the glass pane attachment step S600 may be the external-glass-pane attachment step S600b.

In the feed line connection step S400, one end portion of the feed line 1100f may be connected to one side of the antenna pattern 1100. In the spacer arrangement step S510, to cover the antenna pattern 1100 to which the feed line 1100f is connected, the adhesive layer may be formed, or the spacer 1050s with a predetermined height may be arranged in a peripheral region of the internal glass pane 310. In the external-glass-pane attachment step S600b, the internal glass pane 310, which is arranged to face inward toward the interior of the building, may be attached to an upper region of the spacer 1050s. The spacer 1050s may be formed such that a second thickness thereof is greater than the first thickness of the antenna pattern 1100, thereby increasing the radiation efficiency of the antenna pattern 1100.

The glass pane 300 may be in the internal glass pane 310 arranged to face inward toward the interior of the building. When the antenna pattern 1100 is arranged on the internal glass pane 310, the glass pane attachment step S600 may be the external-glass-pane attachment step S600a.

In the feed line connection step S400, one end portion of the feed line 1100f may be connected to one side of the antenna pattern 1100. In the spacer arrangement step S510, to cover the antenna pattern 1100 to which the feed line 1100f is connected, the adhesive layer may be formed, or the spacer 1050s with a predetermined height may be arranged in the peripheral region of the internal glass pane 310. In the external glass pane attachment S600a, the external glass pane 320, which is arranged to face outward from the building, may be attached to the upper region of the spacer 1050s. The spacer 1050s may be formed such that the second thickness thereof is greater than the first thickness of the antenna pattern 1100, thereby increasing the radiation efficiency of the antenna pattern 1100.

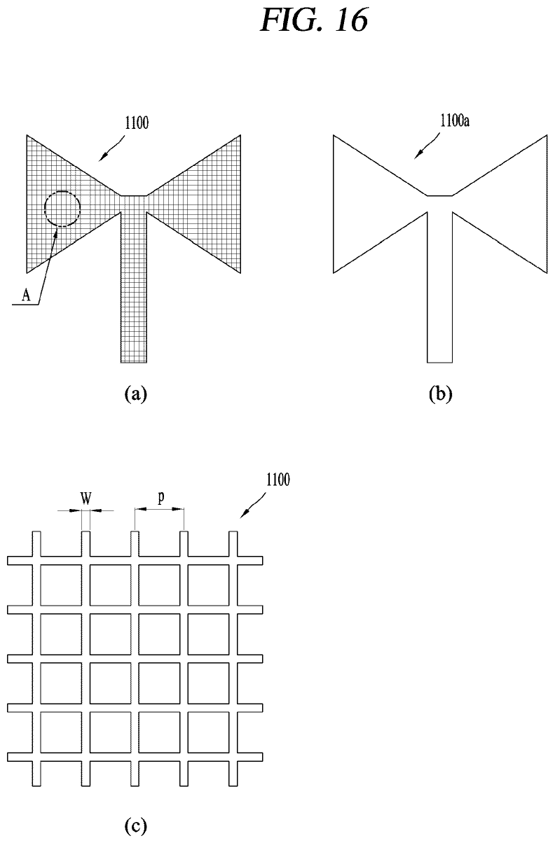

In the transparent antenna module according to the present disclosure, the antenna patterns may form a metal mesh pattern made up of metal mesh lines. In this regard, FIG. 16 is an enlarged view illustrating the metal mesh pattern formed in a specific antenna element and one region of the metal mesh pattern.

The metal mesh pattern formed of a metallic material is used as the antenna pattern 1100 of the transparent antenna according to the present disclosure. As illustrated in (a) of FIG. 16, the antenna patterns 1100 are patterned into the shape of a mesh for use such that they are visually imperceptible to the user. The antenna patterns 1100 may be formed, in an internal region of the antenna element, as metal mesh lines formed of a transparent conductive material, which are arranged along a first axis and a second axis orthogonal to the first axis. The metal mesh lines serving as the antenna patterns 1100 may be formed to have predetermined line widths W. The metal mesh lines, adjacent to the first axis and the second axis, may be formed to be spaced apart by predetermined separation distances p.

An antenna pattern 1100a, which serves as a conductor for an antenna, may also be formed of a highly conductive transparent conductive material by patterning the antenna without forming a mesh pattern. (b) of FIG. 16 illustrates an embodiment of the antenna pattern formed of a transparent conductive material. Examples of the transparent conductive material include silver nanowires, PEDOT:PSS, CNTs, graphene, and similar materials. The antenna patterns 1100a formed of these materials are visually imperceptible to the user. In a case where the antenna pattern 1100 is formed to have a thickness of 1 μm or less, there is no visual effect due to the boundary, so the antenna pattern 1100a may be used without forming a mesh pattern in the same application as the embodiment described above.

With reference to (c) of FIG. 16, the metal mesh lines serving as the antenna patterns 1100 may be formed to have line widths of 2 to 5 μm. However, the metal mesh lines are not limited thereto, and the line widths thereof may vary depending on the intended application. A pitch, which is the separation distance p between adjacent metal mesh lines along the first axis and the second axis, may be set to a range of 70 to 150 μm, but it is not limited thereto. The pitch may vary depending on the intended application. The antenna pattern 1100 may be formed as the metal mesh lines in such a manner as to have a first thickness of 1 μm or less. The first thickness is not limited thereto and may vary depending on the intended application.

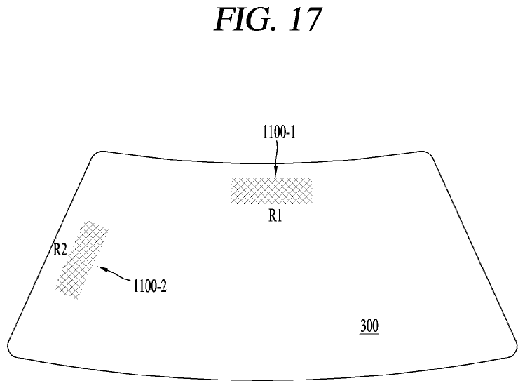

The transparent antenna module according to the present disclosure may be formed with a plurality of antenna structures on a glass pane of a vehicle, particularly, on a front glass pane of the vehicle. In this regard, FIG. 17 is a view illustrating the transparent antenna module formed with multiple antenna structures in different regions of the front glass pane of the vehicle. With reference to FIG. 17, antenna patterns 1100-1 and 1100-2 of the transparent antenna module, when arranged within a double-layered glass pane for a vehicle, may be positioned at positions such as the top and the boundary of the front glass pane of the vehicle. The antenna patterns 1100-1 and 1100-2 lack boundaries when compared to a transparent antenna structure arranged on a separate substrate, thereby providing the effect of receiving communication signals without obstructing the driver's view or affecting the vehicle's exterior design.

With reference to FIGS. 2 to 17, the antenna pattern 1100 may include the first antenna pattern 1100-1 and the second antenna pattern 1100-2 arranged in a lateral region of the front glass pane. The first antenna pattern 1100-1 may be arranged in an upper central region R1 of the glass pane 300 of the vehicle. The second antenna pattern 1100-2 may be arranged in a lateral region R2 of the glass pane 300 of the vehicle.

In the antenna pattern formation step S300 of the method of manufacturing the transparent antenna, the first antenna pattern 1100-1 and the second antenna pattern 1100-2 may be simultaneously deposited on the glass pane 300 of the vehicle. The first antenna pattern 1100-1 and the second antenna pattern 1100-2, which are manufactured by a deposition process, may be formed on the side glass pane 300b and the quarter glass pane 300c of the vehicle, respectively, each not exceeding a predetermined size. The first antenna pattern 1100-1 and the second antenna pattern 1100-2 may perform multiple input and output (MIMO) operations by simultaneously transmitting or receiving a first wireless signal and a second wireless signal in the same frequency band. The first antenna pattern 1100-1 and the second antenna pattern 1100-2 may increase communication capacity for vehicle communication by simultaneously transmitting or receiving different signals.

In the antenna pattern formation step S300, the first antenna pattern 1100-1 may be deposited on a first transfer substrate, and the second antenna pattern 1100-2 may be deposited on a second transfer substrate, thereby enabling the transparent antenna to be formed on the glass pane of the vehicle. In the antenna pattern transfer step S310, the first antenna pattern 1100-1 formed on the first transfer substrate and the second antenna pattern 1100-2 formed on the second transfer substrate may be transferred onto the front glass pane 300a of the vehicle.

In the transfer substrate removal step S320, the first transfer substrate and the second transfer substrate may be removed from the front glass pane 300a of the vehicle. In addition, in the transfer layer removal step S330, the first transfer layer transferred onto the first antenna pattern 1100-1 and the second transfer layer transferred onto the second antenna pattern 1100-2 may be removed. The first antenna pattern 1100-1 and the second antenna pattern 1100-2 may perform multiple input and output (MIMO) operations by simultaneously transmitting or receiving the first wireless signal and the second wireless signal in the same frequency band. The first antenna pattern 1100-1 and the second antenna pattern 1100-2 may increase communication capacity for vehicle communication by simultaneously transmitting or receiving different signals.

The method of manufacturing the transparent antenna according to one aspect of the present disclosure is described above. The transparent antenna module according to one aspect of the present disclosure is described below with reference to FIGS. 2 to 17.

A transparent antenna module 1000 may be configured to include the glass pane 300 and the antenna patterns 1100. The antenna patterns 1100 may be formed on top of the glass pane 300 in such a manner as to be spaced apart by the predetermined separation distance p from each other, thereby radiating wireless signals. The antenna patterns 1100 may be arranged such that the antenna patterns S1100 are positioned between the mask patterns 1100c for antenna patterning. The mask patterns 1100c may be removed from the top of the glass pane 300. As a result, the antenna patterns 1100 may be arranged on top of the glass pane 300 in such a manner as to be spaced apart by the predetermined separation distance p from each other.

The glass pane 300 may be the external glass pane 320 that is arranged to face outward from the vehicle. The transparent antenna module 1000 may further include the feed line 1100f, the adhesive layer 1020, the internal glass pane 310, and the RF cable 310c.

One end of the feed line 1100f may be connected to one side of the antenna pattern 1100, thereby enabling signals to be transmitted to the antenna pattern 1100. The adhesive layer 1020 may be arranged to cover the antenna pattern 1100 to which the feed line 1100f is connected. The internal glass pane 310 may be arranged on the upper region of the adhesive layer 1020 such that the internal glass pane S310 faces inward toward the interior of the vehicle. The RF cable 310c may be connected, by soldering, to the other end portion of the feed line 1100f, which is arranged through a lateral surface of the adhesive layer 1020, a lateral surface of the internal glass pane 310, and the upper region of the internal glass pane 310. The adhesive layer 1020 may be formed such that the second thickness thereof is greater than the first thickness of the antenna pattern 1100.

The glass pane 300 may be the internal glass pane 310 that is arranged to face inward toward the interior of the vehicle. The transparent antenna module 1000 may further include the feed line 1100f, the adhesive layer 1020, the external glass pane 320, and the RF cable 310c.

One end of the feed line 1100f may be connected to one side of the antenna pattern 1100, thereby enabling signals to be transmitted to the antenna pattern 1100. The adhesive layer 1020 may be arranged to cover the antenna pattern 1100 to which the feed line 1100f is connected. The external glass pane 320 may be arranged on the upper region of the adhesive layer 1020 such that the external glass pane S320 faces outward from the vehicle. The RF cable 310c may be connected, by soldering, to the other end portion of the feed line 1100f, which is arranged through a lateral surface of the adhesive layer 1020, a lateral surface of the external glass pane 320, and the upper region of the external glass pane 320. The adhesive layer 1020 may be formed such that the second thickness thereof is greater than the first thickness of the antenna pattern 1100.

The antenna patterns 1100 of the transparent antenna module 1000 may be arranged on the transfer layer 1011 on the transfer substrate 1010. The glass pane 300 may be the glass pane of the vehicle onto which the antenna patterns 1100 formed on the transfer substrate 1010 are transferred for arrangement thereon. The transfer substrate 1010 and the transfer layer 1011 are removed from the glass pane 300 of the vehicle onto which the antenna patterns 1100 are transferred for arrangement thereon. As a result, the antenna patterns 1100 remain on top of the glass pane 300 of the vehicle, thereby being externally exposed.

In this regard, when the antenna patterns 1100 are arranged within the double-layered glass pane structure, the antenna patterns 1100 are arranged between the internal glass pane 310 and the external glass pane 320. The transfer substrate 1010 and the transfer layer 1011 may be removed from the internal glass pane 310 or the external glass pane 320 onto which the antenna patterns 1100 are transferred for arrangement thereon. As a result, the antenna patterns 1100 remain with a double-layered glass structure.

The transparent antenna module according to the present disclosure and the method of manufacturing the transparent antenna module are described above. The technical effects of a transparent antenna module according to the present disclosure and a method of manufacturing the transparent antenna module can be summarized as follows, without limiting the scope of the present disclosure.

The transparent antenna module according to the present disclosure features a structure that eliminates the user's perception of the boundary of the antenna and enables the antenna pattern to be directly formed on the glass pane of a product. Accordingly, when the transparent antenna module is mounted on the exterior of an application product equipped with communication functionality, the effects of avoiding degradation in communication performance and damage to exterior design can be achieved.

In addition, the structure of the antenna module, unlike that of a normal transparent antenna module, eliminates the need for a substrate and a protective layer, thereby achieving the effect of reducing manufacturing costs.

The further scope of applicability of the present disclosure will become apparent from the following detailed description. However, various alterations and modifications to the present disclosure would be readily understood by a person of ordinary skill in the art without departing from the spirit and scope of the technical idea of the present disclosure. The detailed description and specific embodiments, such as preferred embodiments of the disclosure, should be understood as illustrative examples only.

The transparent antenna module according to the present disclosure and the method of manufacturing the transparent antenna module, which are described above, can be implemented as computer-readable code on a medium where a program is recorded. The computer-readable media include all types of recording devices capable of storing data that are readable by a computer system. Furthermore, examples of the computer-readable media include hard disk drives (HDDs), solid-state disks (SSDs), a silicon disk drive (SDD), ROM, RAM, CD-ROMs, magnetic tapes, floppy disks, an optical data storage devices, and similar storage devices. The computer-readable medium may also be realized in the form of a carrier wave (such as for transmission over the Internet). In addition, the computer may include a control unit of a terminal. Therefore, the description detailed above should be regarded as exemplary, without being interpreted as limiting in any respect. The scope of the present disclosure should be determined by the proper construction of the following claims. All equivalent modifications to the embodiments of the present disclosure fall within the scope of the present disclosure.

What is claimed is:

1. A method of manufacturing a transparent antenna module, the method comprising:
a mask pattern formation step of forming mask patterns for antenna patterning on top of a glass pane or a transfer substrate;
an antenna pattern formation step of forming antenna patterns on top of the glass pane or the transfer substrate such that the antenna patterns are positioned between the mask patterns; and
a mask pattern removal step of removing the mask patterns from the top of the glass pane or the transfer substrate such that only the antenna patterns remain on top of the glass pane or the transfer substrate.

2. The method of claim 1, wherein the antenna patterns form an antenna region radiating wireless signals,
wherein the mask pattern coupled to either of the outermost antenna patterns, among the antenna patterns, is formed such that a first width thereof is greater than a second width of the mask pattern in the central portion of the antenna region, and
wherein the mask patterns are formed such that gaps between the mask patterns decrease in the central portion of the antenna region, and thus, line widths of metal mesh lines, which correspond to widths of the antenna patterns positioned between the mask patterns, increase in the central portion.

3. The method of claim 1, wherein the glass pane is an external glass pane arranged to face outward from a vehicle, further comprising:
a feed line connection step of connecting one end portion of a feed line to one side of the antenna pattern;
an adhesive layer formation step of forming an adhesive layer in such a manner to cover the antenna pattern to which the feed line is connected; and
an internal-glass-pane attachment step of attaching an internal glass pane to an upper region of the adhesive layer in such a manner as to face inward toward the interior of the vehicle,
wherein a second thickness of the adhesive layer is greater than a first thickness of the antenna pattern.

4. The method of claim 3, further comprising:
a feed line arrangement step of arranging the feed line on an upper region of the internal glass pane through a lateral surface of the adhesive layer and a lateral surface of the internal glass pane; and
a cable connection step of connecting the other end portion of the feed line arranged on the upper region of the internal glass pane to an RF cable.

5. The method of claim 1, wherein the glass pane is an internal glass pane arranged to face inward toward a vehicle, comprising:
a feed line connection step of connecting one end portion of a feed line to one side of the antenna pattern;
an adhesive layer formation step of forming an adhesive layer in such a manner as to cover the antenna pattern to which the feed line is connected; and
an external-glass-pane attachment step of attaching an external glass pane to an upper region of the adhesive layer in such a manner as to face outward from the vehicle,
wherein a second thickness of the adhesive layer is greater than a first thickness of the antenna pattern.

6. The method of claim 5, further comprising:
a feed line arrangement step of arranging the feed line on an upper region of the external glass pane through a lateral surface of the adhesive layer and a lateral surface of the external glass pane; and
a cable connection step of connecting the other end portion of the feed line arranged on the upper region of the external glass pane to an RF cable.

7. The method of claim 1, wherein the antenna patterns are arranged on a transfer layer on the transfer substrate, further comprising, before the mask pattern formation step:
a transfer layer formation step of forming the transfer layer on the transfer substrate and, further comprising, after the mask pattern removal step:
an antenna pattern transfer step of transferring the antenna patterns formed on the transfer substrate onto a glass pane intended to be installed in a vehicle; and
a transfer substrate removal step of removing the transfer substrate from the glass pane onto which the antenna patterns are transferred.

8. The method of claim 7, further comprising:
a transfer layer removal step of removing the transfer layer arranged on upper regions of the antenna patterns.

9. The method of claim 1, wherein the glass pane is a cover glass pane of a display panel, further comprising:
a feed line connection step of connecting one end portion of a feed line to one side of the antenna pattern;
a first-adhesive-layer formation step of forming a first adhesive layer in such a manner as to cover the antenna pattern to which the feed line is connected;
a touch sensor layer formation step of forming a touch sensor layer, on which a touch sensor is formed, on top of the first adhesive layer;
a second-adhesive-layer formation step of forming a second adhesive layer on top of the touch sensor layer; and
a display panel attachment step of attaching the display panel on top of the second adhesive layer.

10. The method of claim 1, wherein the glass pane is an external glass pane arranged to face outward from a building, comprising:
a feed line connection step of connecting one end portion of a feed line to one side of the antenna pattern;
a spacer arrangement step of forming an adhesive layer in such a manner as to cover the antenna pattern to which the feed line is connected or arranging a spacer with a predetermined height in a peripheral region of the internal glass pane; and
an internal-glass-pane attachment step of attaching an internal glass pane to an upper region of the spacer in such a manner as to face inward toward the interior of the building,
wherein a second thickness of the spacer is greater than a first thickness of the antenna pattern.

11. The method of claim 1, wherein the glass pane is an internal glass pane arranged to face inward toward the interior of a building, comprising:
a feed line connection step of connecting one end portion of a feed line to one side of the antenna pattern;
a spacer arrangement step of forming an adhesive layer in such a manner as to cover the antenna pattern to which the feed line is connected or arranging a spacer with a predetermined height in a peripheral region of the internal glass pane; and
an external-glass-pane attachment step of attaching an external glass pane to an upper region of the spacer in such a manner as to face outward from the building,
wherein a second thickness of the spacer is greater than a first thickness of the antenna pattern.

12. The method of claim 3, wherein the antenna patterns are formed, in an internal region of the antenna element, as metal mesh lines formed of a transparent conductive material, arranged along a first axis and a second axis orthogonal to the first axis,
wherein the metal mesh lines have predetermined line widths W and adjacent metal mesh lines along the first axis, and the second axis are spaced apart by a predetermined separation distance p, and
wherein the antenna pattern is formed as the metal mesh lines in such a manner as to have a first thickness of 1 μm or less.

13. The method of claim 3, wherein the antenna pattern includes a first antenna pattern arranged in an upper central region of the glass pane of the vehicle and a second antenna pattern arranged in a lateral region,
wherein in the antenna pattern formation step, the first antenna pattern and the second antenna pattern are simultaneously deposited on top of the glass pane of the vehicle, and
wherein the first antenna pattern and the second antenna pattern perform multiple input and multiple output (MIMO) operations by simultaneously transmitting or receiving a first wireless signal and a second wireless signal in the same frequency band.

14. The method of claim 7, wherein the antenna pattern includes a first antenna pattern arranged in an upper central region of a front glass pane of the vehicle and a second antenna pattern arranged in a lateral region,
wherein in the antenna pattern formation step, the first antenna pattern is deposited on a first transfer substrate, and the second antenna pattern is deposited on a second transfer substrate,
wherein in the antenna pattern transfer step, the first antenna pattern formed on the first transfer substrate and the second antenna pattern formed on the second transfer substrate are transferred onto the front glass pane of the vehicle,
wherein in the transfer substrate removal step, the first transfer substrate and the second transfer substrate are removed from the front glass pane of the vehicle, and
wherein the first antenna pattern and the second antenna pattern perform multiple input and multiple output (MIMO) operations by simultaneously transmitting or receiving a first wireless signal and a second wireless signal in the same frequency band.

15. A transparent antenna module comprising:
a glass pane; and
antenna patterns arranged on top of the glass pane in such a manner as to be spaced apart by a predetermined separation distance from each other, thereby radiating wireless signals,
wherein the antenna patterns are arranged to be positioned between mask patterns for antenna patterning and,
wherein the mask patterns are removed from the top of the glass pane, and the antenna patterns are arranged on top of the glass pane in such a manner as to be spaced apart by a predetermined separation distance.

16. The transparent antenna module of claim 15, wherein the antenna patterns form an antenna region radiating wireless signals,
wherein the mask pattern coupled to either of the outermost antenna patterns, among the antenna patterns, is formed such that a first width thereof is greater than a second width of the mask pattern in the central portion of the antenna region, and
wherein the mask patterns are formed such that gaps between the mask patterns decrease in the central portion of the antenna region, and thus, line widths of metal mesh lines, which correspond to widths of the antenna patterns positioned between the mask patterns, increase in the central portion.

17. The transparent antenna module of claim 15, wherein the glass pane is an external glass pane arranged to face outward from a vehicle, comprises:
a feed line, one end portion of which is connected to one side of the antenna pattern and along which signals are transmitted to the antenna pattern;
an adhesive layer arranged to cover the antenna pattern to which the feed line is connected;
an internal glass pane arranged on an upper region of the adhesive layer in such a manner as to face inward toward the interior of the vehicle; and
an RF cable connected, through soldering, to the other end portion of the feed line arranged through a lateral surface of the adhesive layer, a lateral surface of the internal glass pane, and an upper region of the internal glass pane,
wherein a second thickness of the adhesive layer is greater than a first thickness of the antenna pattern.

18. The transparent antenna module of claim 15, wherein the glass pane is arranged to face inward toward the interior of a vehicle, comprises:
a feed line, one end portion of which is connected to one side of the antenna pattern and along which signals are transmitted to the antenna pattern;
an adhesive layer arranged to cover the antenna pattern to which the feed line is connected;
an external glass pane arranged on an upper region of the adhesive layer in such a manner as to face outward from the vehicle; and
an RF cable connected, through soldering, to the other end portion of the feed line arranged through a lateral surface of the adhesive layer, a lateral surface of the external glass pane, and an upper region of the external glass pane,
wherein a second thickness of the adhesive layer is greater than a first thickness of the antenna pattern.

19. The transparent antenna module of claim 15, wherein the antenna patterns are arranged on a transfer layer on a transfer substrate,
wherein the glass pane is a glass pane of a vehicle, onto which the antenna patterns formed on the transfer substrate are transferred for arrangement thereon, and
wherein the transfer substrate and the transfer layer are removed from the glass pane of the vehicle, onto which the antenna patterns are transferred for arrangement thereon, and thus, the antenna patterns remain on top of the glass pane of the vehicle, thereby being externally exposed.
